(19) United States
(12) Patent Application Publication
(10) Pub. No.: US 2015/0130726 A1
(43) Pub. Date: May 14, 2015

(54) ORGANIC LIGHT-EMITTING DIODE (OLED) DISPLAY

(71) Applicant: Samsung Display Co., Ltd., Yongin-City (KR)

(72) Inventors: Byung Chan MIN, Yongin-si (KR); Hyun-Wook Cho, Cheonan-si (KR); Je Young Park, Cheonan-si (KR)

(73) Assignee: Samsung Display Co., Ltd., Yongin-City (KR)

(21) Appl. No.: 14/270,015

(22) Filed: May 5, 2014

(30) Foreign Application Priority Data
Nov. 8, 2013 (KR) 10-2013-0135618

(51) Int. Cl. G06F 3/041; G06F 3/044; G09G 3/32

(52) U.S. Cl. CPC G06F 3/0412; G09G 3/3225; G06F 3/044; G06F 2203/04102; G06F 2203/04112; G06F 2203/04111
USPC 345/173; 345/76

(57) ABSTRACT

An organic light-emitting diode (OLED) display is disclosed. In one aspect, the OLED display includes a substrate and a thin film display layer formed over the substrate, wherein a plurality of OLEDs are formed in the thin film display layer. The OLED display also includes an encapsulation substrate formed over the thin film display layer, a touch sensing layer formed over the encapsulation substrate, and a flexible printed circuit board connected to the substrate and the touch sensing layer. The flexible printed circuit board includes a display unit electrically connected to the substrate and a touch unit extending from the display unit and electrically connected to the touch sensing layer

### CROSS-REFERENCE TO RELATED APPLICATION

This application claims priority to and the benefit of Korean Patent Application No. 10-2013-0135618 filed in the Korean Intellectual Property Office on Nov. 8, 2013, the entire contents of which are incorporated herein by reference.

### BACKGROUND

1. Field

The described technology generally relates to an organic light-emitting diode (OLED) display, and more particularly, to an OLED display including a touch sensing layer.

2. Description of the Related Technology

Display devices, such as liquid crystal displays (LCDs), organic light-emitting diode (OLED) displays, and electrophoretic displays, include an electric field generating electrode and an electro-optical active layer. In OLED displays, an organic emission layer functions as the electro-optical active layer.

OLED displays also include a display substrate which has a display area in which images can be displayed and a peripheral area surrounding the display area. An encapsulation substrate is formed on the display substrate to protect the electromechanical components of the display.

Recently, display devices have been developed to include touch input functionality in order to receive touch input in addition to displaying images. In order to receive the touch input, the display device detects a change in pressure, capacitance, or received light when a user brings a finger or touch pen close to the screen. The touch input can be recognized either when an object approaches or is in contact with the screen. The display device displays images in response the touch input.

Touch input is implemented by a touch sensor. Various types of touch sensors can be employed, such as resistive, capacitive, electro-magnetic (EM), or optical sensing touch sensors.

### SUMMARY OF CERTAIN INVENTIVE ASPECTS

One inventive aspect is an organic light-emitting diode (OLED) display including a touch sensing layer in which a flexible printed circuit board for a touch sensing layer and a circuit board for a display device are integrally formed.

Another aspect is an OLED display including a substrate, a thin film layer which is formed on the substrate and includes a plurality of OLEDs, an encapsulation substrate which is formed on the thin film layer, a touch sensing layer which is formed on the encapsulation substrate, and a flexible printed circuit board which is connected to the substrate and the touch sensing layer, in which the flexible printed circuit board includes a display unit which is connected to the substrate and a touch unit which extends from the display unit and is connected to the touch sensing layer.

The flexible printed circuit board may further include a display terminal which is formed in the display unit and a touch terminal which is formed in the touch unit.

The display terminal and the touch terminal may be separated from each other.

The flexible printed circuit board may further include an input unit which is applied with a driving signal of the pixel and a sensing input signal of the touch sensing layer from the outside and a touch driver which is applied with the sensing input signal from the input unit to transmit the sensing input signal to the touch sensing layer.

The input unit may be formed in the display unit and the touch driver may be formed in the touch unit.

The OLED display may further include a signal driver which is formed on the substrate and the display unit may be applied with the driving signal of the pixel from the input unit to transmit the driving signal to the driving driver.

The touch sensing layer may include a plurality of first touch electrodes and a plurality of second touch electrodes which are separated from the first touch electrodes and formed on the same layer as the first touch electrodes.

The first touch electrode and the second touch electrode may be alternately arranged so as not to overlap each other, the plurality of first touch electrodes which are arranged in a first direction may be connected to each other by a plurality of first connection units, and the plurality of second touch electrodes which are arranged in a second direction which is different from the first direction may be connected to each other by a plurality of second connection units.

The first connection unit may be formed on the same layer as the first touch electrode and integrally formed with the first touch electrode and the second connection unit may be formed on a layer which is different from the second touch electrode.

The OLED display may further include a first touch wiring line which is connected to the first touch electrode, and a second touch wiring line which is connected to the second touch electrode in which end portions of the first touch wiring line and the second touch wiring line may form a touch pad unit which is connected with the touch unit.

The touch unit may be spaced apart from the substrate.

Another aspect is an OLED display including a substrate including a display area and a peripheral area, a plurality of pixels formed in the display area, a signal driver formed in the peripheral area and configured to apply driving signals to the pixels, a touch sensing layer formed over the pixels, and a flexible circuit board including a display input portion and a touch driver portion, wherein the display input portion is electrically connected to the signal driver and wherein the touch driver portion is electrically connected to the touch sensing layer.

The flexible circuit board further includes an input unit configured to receive the driving signals and a touch driving signal from an external source, the display input portion is configured to receive the driving signals from the input unit and apply the driving signals to the signal driver, and the touch driver portion includes a touch driver configured to receive the touch driving signal from the input unit and apply the touch driving signal to the touch sensing layer. The input unit is formed in the display input portion.

The display input portion includes a display terminal electrically connected to the signal driver, the touch driver portion includes a touch terminal electrically connected to the touch sensing layer, and the display terminal and the touch terminal are spaced apart.

The touch sensing layer includes a plurality of first touch electrodes arranged in a first direction, a plurality of second touch electrodes arranged in a second direction crossing the first direction, a plurality of first touch wiring lines, wherein each of the first touch wiring lines is respectively electrically connected to one of the first touch electrodes, and a plurality of second touch wiring lines, wherein each of the second touch wiring lines is respectively electrically connected to one of the second touch electrodes.

The touch sensing layer further includes a touch pad electrically connected to the touch driver portion and wherein each of the first and second touch wiring lines is electrically connected to the touch pad.

The touch sensing layer further includes a plurality of first connection units electrically connecting the first touch electrodes and a plurality of second connection units electrically connecting the second touch electrodes.

The first and second touch electrodes are formed on the same layer, the first connection units are formed on the same layer as the first and second touch electrodes, and the second connection units are formed on a different layer from the first and second touch electrodes. The touch driver portion is spaced apart from the substrate.

According to at least one embodiment a flexible circuit board for a touch sensing layer and a circuit board for a display device are integrally formed so that production cost is reduced as compared with the related art and a defect in which the connector is broken or driving failure due to a connection failure of a separate flexible printed circuit board does not occur.

Further, the touch sensing layer is formed on an encapsulation substrate so that the thickness of the overall product may be reduced as compared with a product of the related art in which the touch panel is attached onto the encapsulation substrate.

### BRIEF DESCRIPTION OF THE DRAWINGS

FIG. 1 is a top plan view schematically illustrating an OLED display according to an exemplary embodiment.

FIG. 2 is a side view schematically illustrating the OLED display of FIG. 1.

FIG. 3 is a top plan view illustrating a touch sensing layer of the OLED display of FIG. 1.

FIG. 4 is an enlarged view of a part of the touch sensing layer of FIG. 3.

FIG. 5 is a cross-sectional view taken along the line V-V of FIG. 4.

FIG. 6 is an equivalent circuit diagram of one pixel of an OLED display according to an exemplary embodiment.

FIG. 7 is a layout diagram of one pixel of an OLED display according to an exemplary embodiment.

FIG. 8 is a cross-sectional view taken along the line III-III of FIG. 7.

### DETAILED DESCRIPTION OF CERTAIN INVENTIVE EMBODIMENTS

Touch input is typically implemented in display devices by attaching a touch panel including a touch sensor to a display panel. However, when the separately manufactured panels are mated, the overall thickness of the display device increases. Further, flexible printed circuit boards for the panels are generally separately manufactured, requiring a connector for electrical/data communication between the boards. However, the connector can be broken, separating the boards.

Hereinafter, exemplary embodiments of the described technology will be described in detail with reference to the accompanying drawings. As those skilled in the art would realize, the described embodiments may be modified in various different ways, all without departing from the spirit or scope of the described technology. The exemplary embodiments introduced herein are provided to make the disclosed contents thorough and complete and sufficiently transfer the spirit of the described technology to those skilled in the art.

In the drawings, the thicknesses of layers, films, panels, regions, etc., may be exaggerated for clarity. It will be understood that when a layer is referred to as being “on” another layer or substrate, it can be directly on the other layer or substrate, or intervening layers or components may also be present. Like reference numerals designate like elements throughout the specification.

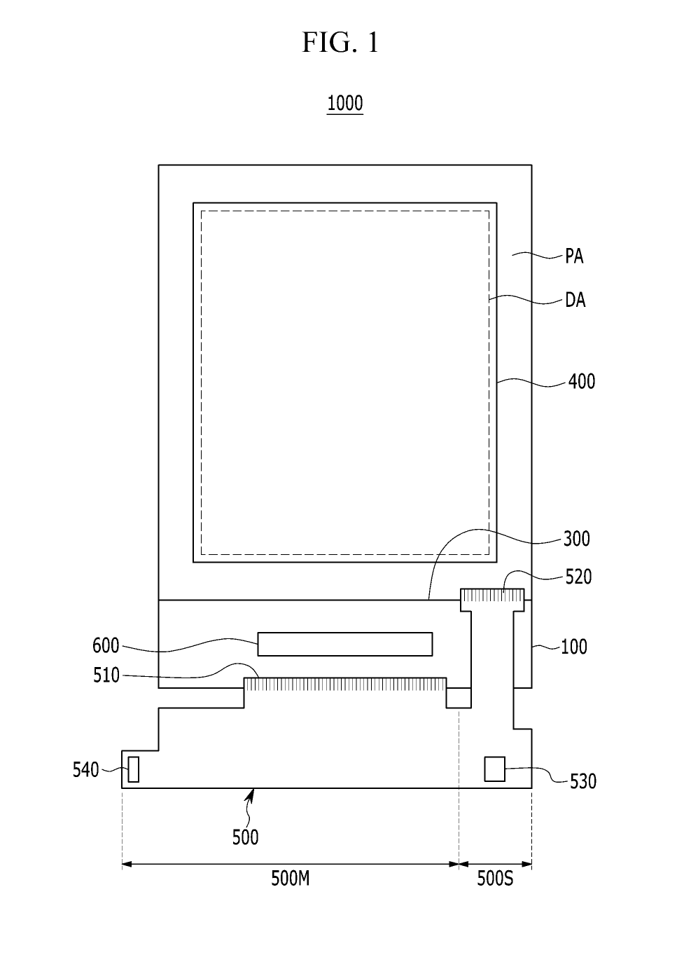

An organic light-emitting diode (OLED) display according to an exemplary embodiment will be described with reference to FIGS. 1 to 8.

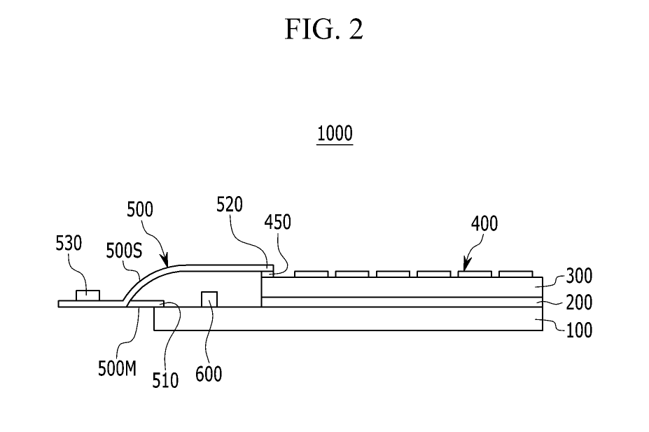

FIG. 1 is a top plan view schematically illustrating an OLED display according to an exemplary embodiment and FIG. 2 is a side view schematically illustrating the OLED display of FIG. 1.

Referring to FIGS. 1 and 2, the OLED display 1000 includes a substrate 100, a thin film display layer 200, an encapsulation substrate 300, and a touch sensing layer 400 sequentially formed on the substrate 100. The OLED display 1000 further includes a flexible printed circuit board 500 connected to the substrate 100 and the encapsulation substrate 300.

The OLED display 1000 may further include a window (not illustrated) which is formed on the touch sensing layer 400 to protect the thin film display layer 200 and the touch sensing layer 400.

The OLED display 1000 also includes a display area DA on which an image is displayed and a peripheral area PA surrounding the display area DA in plan view.

A plurality of pixels are formed in the display area DA. Each pixel includes a switching thin film transistor T1, a driving thin film transistor T2, a storage capacitor Cst, and an OLED, which will be described below. The thin film display layer 200 includes a plurality of switching and driving thin film transistors T1 and T2, a plurality of storage capacitors Cst, and a plurality of OLEDs.

A signal driver 600 which drives the plurality of pixels is formed on the substrate 100 in the peripheral area PA.

A touch pad unit 450 is formed on the encapsulation substrate 300 in the peripheral area PA.

The touch sensing layer 400 is formed on the encapsulation substrate 300 to measure touch input. The touch sensing layer 400 measures touch input when an object approaches the touch sensing layer 400 or is in contact with the touch sensing layer 400. Here, touch input includes not only when an object such the hand of a user is in direct contact with the touch sensing layer 400 but also when an object approaches the touch sensing layer 400 or hovers over the touch sensing layer 400.

The flexible printed circuit board 500 includes a display unit or display input portion 500M and a touch unit or touch driver portion 500S.

The touch unit 500S extends from the display unit 500M. A display terminal 510 is connected to the substrate 100 and is formed in the display unit 500M. A touch terminal 520 is connected to the touch pad unit or touch pad 450 of the encapsulation substrate 300 and is formed in the touch unit 500S. The display terminal 510 and the touch terminal 520 are separated from each other. The display unit 500M is connected to the signal driver 600 which is formed on the substrate 100 through the display terminal 510. The touch unit 500S is connected to the touch sensing layer 400 which is formed on the encapsulation substrate 300 through the touch terminal 520.

Further, an input unit 540 which receives signals from an external source is formed in the display unit 500M and a touch driver 530 is formed in the touch unit 500S.

The display unit 500M received driving signals for the pixels from the external source through the input unit 540 and transmits the driving signals to the signal driver 600.

The touch driver 530 receives a touch driving signal for the touch sensing layer 400 from the external source through the input unit 540 and transmits the touch driving signal to the touch sensing layer 400. Further, the touch driver 530 receives a touch output signal from the touch sensing layer 400 and processes the touch output signal.

As described above, the flexible printed circuit board 500 includes the touch unit 500S which extends from the display unit 500M so that the display unit 500M and touch unit 500S do not need to be formed on separate flexible printed circuit boards.

Accordingly, there is no need to provide a connector as used in the standard flexible printed circuit board to connect the flexible printed circuit boards respectively connected to the signal driver 600 and touch sensing layer 400.

As described above, according to at least one embodiment, the flexible printed circuit board 500 is connected to the signal driver 600 and the touch sensing layer 400 and is integrally formed, thereby reducing the manufacturing cost when compared with the standard flexible printed circuit board. Additionally, defects or mechanical failures such as the connector being broken or driving failure caused by connection failure between separate flexible printed circuit boards can be substantially prevented.

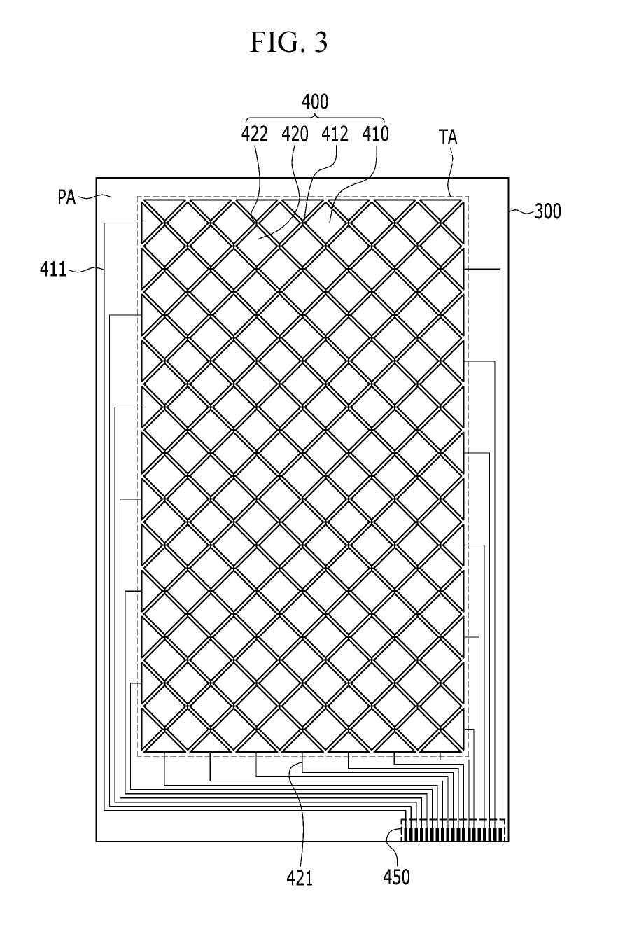

Next, the touch sensing layer according to an exemplary embodiment will be described with reference to FIGS. 3 to 5.

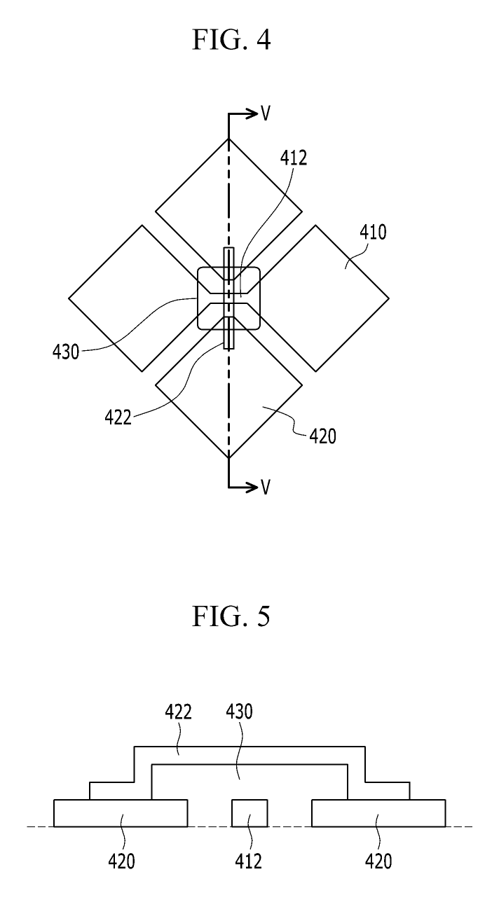

FIG. 3 is a top plan view illustrating a touch sensing layer of the OLED display of FIG. 1. FIG. 4 is an enlarged view of a part of the touch sensing layer of FIG. 3. FIG. 5 is a cross-sectional view taken along the line V-V of FIG. 4.

Referring to FIG. 3, the touch sensing layer 400 is formed on the encapsulation substrate 300. The touch sensing layer 400 is formed in a touch active area TA where touch input can be measured. In some embodiments, the touch active area TA is the entire display area DA or also includes a part of the peripheral area PA. In other embodiments, only a part of the display area DA forms the touch active area TA.

The touch sensing layer 400 can receive touch input in various ways. For example, various types of touch sensors can be employed, such as resistive type, capacitive type, electro-magnetic type (EM), or optical sensing type touch sensors.

In the embodiment of FIG. 3, a capacitive type touch sensing sensor is illustrated and will be described as an embodiment.

The touch sensing layer 400 includes a plurality of touch electrodes and the touch electrodes include a plurality of first touch electrodes 410 and a plurality of second touch electrodes 420. The first and second touch electrodes 410 and 420 are separated from each other.

The first and second touch electrodes 410 and 420 are alternately arranged so as not to overlap each other in the touch active area TA. The first touch electrodes 410 are arranged in a row direction and the second touch electrodes 420 are arranged in a column direction.

The first and second touch electrodes 410 and 420 are formed on the same layer.

The first and second touch electrodes 410 and 420 may have quadrangular shapes but, are not limited thereto, and may have various shapes such as a protruding portion in order to improve the sensitivity of the touch sensing layer 400.

In the embodiment of FIG. 3, the first touch electrodes 410 arranged in the same row are connected to each other and the first touch electrodes 410 arranged in the same column are separated from each. Similarly, the second touch electrodes 420 arranged in the same column are connected to each other and the second touch electrodes 420 arranged in the same row are separated from each. According to other embodiments, the first touch electrodes 410 are connected in the column direction and the second touch electrodes 420 are connected in the row direction.

More specifically, the plurality of first touch electrodes 410 arranged in each row are connected to each other through a first connection unit 412 and the second touch electrodes 420 arranged in each column are connected to each other through a second connection unit 422.

Referring to FIGS. 4 and 5, the first connection unit 412 connects adjacent first touch electrodes 410 and is formed on the same layer as the first touch electrode 410. Further, the first connection unit 412 is formed of the same material as the first touch electrode 410. That is, in the embodiment of FIGS. 4 and 5, the first touch electrode 410 and the first connection unit 412 are integrally formed and simultaneously patterned.

The second connection unit 422 connects adjacent second touch electrodes 420 and is formed on a different layer from that of the second touch electrodes 420. That is, the second touch electrode 420 and the first connection unit 412 are separated from each other and separately patterned. The second touch electrode 420 and the second connection unit 422 are connected to each other through a direct connection.

An insulating layer 430 is formed between the first connection unit 412 and the second connection unit 422 to insulate the first and second connection units 412 and 422 from each other. As illustrated in FIGS. 4 and 5, the insulating layer 430 is formed of a plurality of separate island shaped insulators formed at the intersections between the first and second connection units 412 and 422. The insulating layer 430 exposes at least a part of the second touch electrodes 420 so that the second connection unit 422 is connected to the second touch electrodes 420.

The insulating layer 430 may have a shape having rounded edges or a polygonal shape.

Further, the shape of the insulating layer 430 is not limited to the above described shapes; the insulating layer 430 may be formed on the entire area and portions of the insulating layer 430 formed over the second touch electrodes 420 may be removed to connect the second touch electrodes 420 which are adjacent to each other in the column direction through the second connection units 422.

According to some embodiments, the second connection unit 422 which connects the adjacent second touch electrodes 420 is formed on the same layer as the first touch electrodes 410 and is formed at the same time as the first touch electrodes 410. In these embodiments, the first connection units 412 which connect the adjacent first touch electrodes 410 are formed on a different layer from the first touch electrodes 410, in contrast to the illustration of FIGS. 4 and 5.

Referring to FIG. 3 again, the first touch electrodes 410 arranged in the respective rows and are connected to each other are connected to the touch driver 530 through first touch wiring lines 411 and the second touch electrodes 420 arranged in the respective columns and are connected to each other are connected to the touch driver 530 through second touch wiring lines 421. The first and second touch wiring lines 411 and 421 are formed in the peripheral area PA of the encapsulation substrate 300 as illustrated in FIG. 3. According to other embodiments, the first and second touch wiring lines 411 and 412 are formed in the touch active area TA.

End portions of the first and second touch wiring lines 411 and 421 form a pad unit 450 in the peripheral area PA of the encapsulation substrate 300.

The first and second touch electrodes 410 and 420 have a predetermined transmittance or greater so that light is transmitted from the thin film display layer 200. In some embodiments, the first and second touch electrodes 410 and 420 are formed of a thin metal layer such as indium tin oxide (ITO), indium zinc oxide (IZO), or silver nano wire (AgNw) or a transparent conductive material such as metal mesh or a carbon nanotube (CNT), but are not limited thereto.

The first and second touch wiring lines 411 and 421 may be formed of the same transparent conductive material as the first and second touch electrodes 410 and 420 or a low resistive material such as molybdenum (Mo), silver (Ag), titanium (Ti), copper (Cu), aluminum (Ti), or molybdenum/aluminum/molybdenum (Mo/Al/Mo).

The first and second touch electrodes 410 and 420 which are adjacent to each other form a mutual sensing capacitor which serves as a touch sensor. The mutual sensing capacitor receives the touch driving signal through one of the first and second touch electrodes 410 and 420 and the touch input of an external object changes the capacitance between the first and second electrodes, resulting in a change in the stored charge. The change in stored charge is output as a touch output signal through the other touch electrode.

According to some embodiments, the first and second touch electrodes 410 and 420 are separated from each other and respectively connected to a touch controller 700 through touch wiring lines (not illustrated), different from FIGS. 3 to 5. In these embodiments, each of the touch electrodes may form a self-sensing capacitor as a touch sensor. The self-sensing capacitor receives the touch driving signal and is charged to a predetermined level. Upon receiving a touch input from an external object such as a finger, the charge level is changed and a sensing output signal different from the input touch driving signal is output.

As described above, the touch sensing layer 400 is formed on the encapsulation substrate 300 so that a thickness of entire product is reduced when compared with a touch panel that is attached onto the encapsulation substrate.

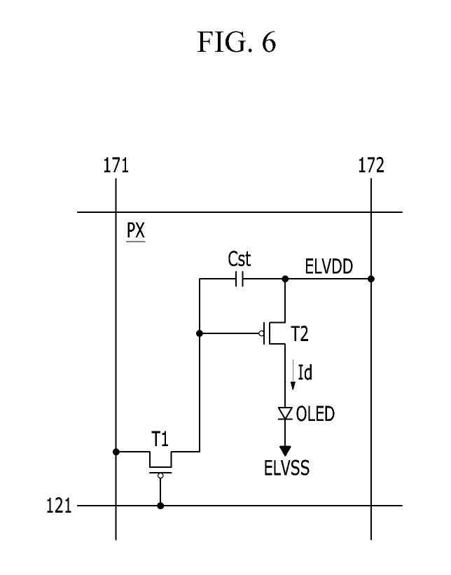

Next, a pixel of the OLED display according to an embodiment will be described in detail with reference to FIGS. 6 to 8.

As mentioned above, the thin film display layer 200 includes a plurality of switching and driving thin film transistors T1 and T2, a plurality of storage capacitors Cst, and a plurality of OLEDs. That is, the thin film display layer 200 includes a plurality of pixels.

FIG. 6 is an equivalent circuit diagram of one pixel of the OLED display according to an exemplary embodiment.

Referring to FIG. 6, the OLED display includes a plurality of signal lines 121, 171, and 172 and a plurality of pixels PX connected thereto and arranged in a matrix.

The signal lines include a plurality of gate lines 121 which transmit gate signals (or scan signals), a plurality of data lines 171 which transmit data signals, and a plurality of driving voltage lines 172 which transmit a driving voltage (ELVDD). The gate and data signals are applied through the signal driver 600.

The gate lines 121 extend in a row direction and are substantially parallel to each other and the data lines 171 and the driving voltage lines 172 extend in a column direction and are substantially parallel to each other.

Each pixel PX includes a switching thin film transistor T1, a driving thin film transistor T2, a storage capacitor Cst, and an OLED.

The switching thin film transistor T1 includes a control terminal, an input terminal, and an output terminal. The control terminal is connected to the gate line 121, the input terminal is connected to the data line 171, and the output terminal is connected to the driving thin film transistor T2. The switching thin film transistor T1 transmits the data signal received from the data line 171 to the driving thin film transistor T2 in response to the gate signal which is received from the gate line 121.

The driving thin film transistor T2 also has a control terminal, an input terminal, and an output terminal. The control terminal is connected to the switching thin film transistor T1, the input terminal is connected to the driving voltage line 172, and the output terminal is connected to the OLED. The driving thin film transistor T2 applies an output current Id with a level depending on the voltage applied between the control terminal and the output terminal.

The storage capacitor Cst is connected between the control terminal and the input terminal of the driving thin film transistor T2. The storage capacitor Cst stores a data signal applied to the control terminal of the driving thin film transistor T2 and maintains the data signal even after the switching thin film transistor T1 is turned off.

The OLED has an anode which is connected to the output terminal of the driving thin film transistor T2 and a cathode which is connected to a common voltage (ELVSS). The OLED emits light with a varying intensity in accordance with the output current Id of the driving thin film transistor T2 to display an image.

The switching thin film transistor T1 and the driving thin film transistor T2 may be n channel electric field effect transistors (FETs) or a p channel FETs. The connection relationship between the switching and driving thin film transistors T1 and T2, the storage capacitor Cst, and the OLED may be changed according to design requirements.

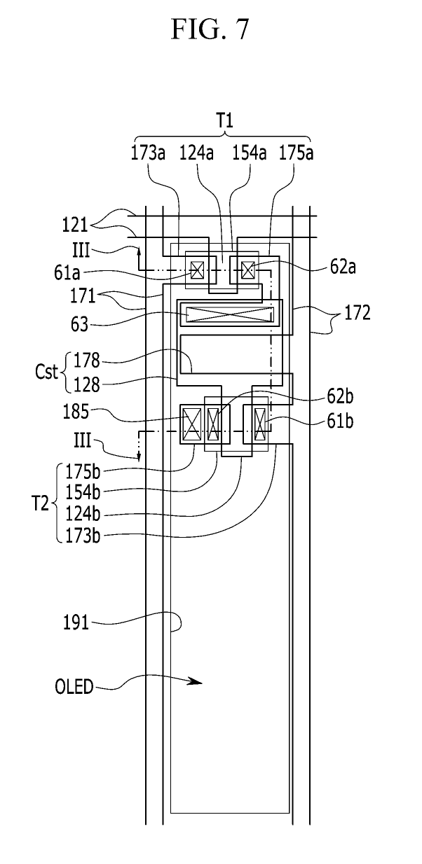

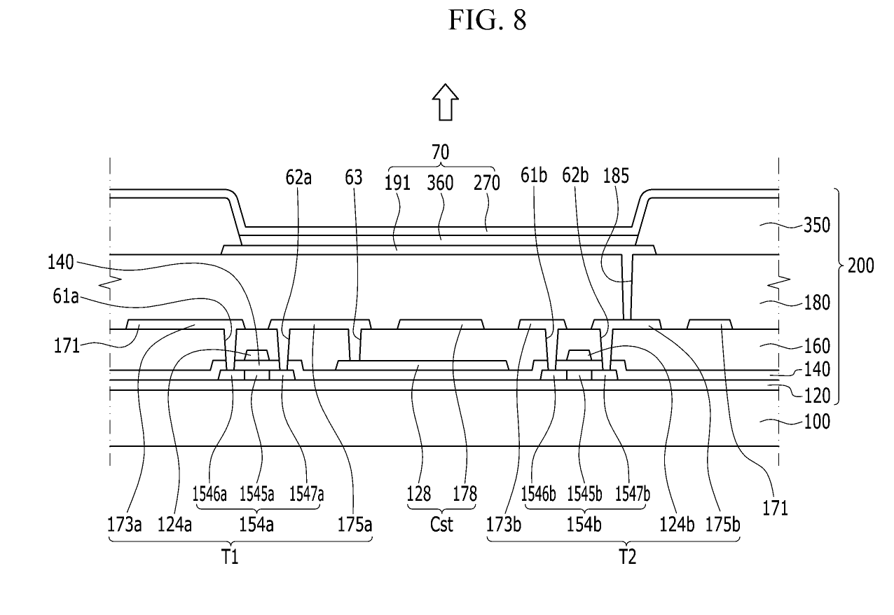

FIG. 7 is a layout diagram of one pixel of an OLED display according to an exemplary embodiment. FIG. 8 is a cross-sectional view taken along the line III-III of FIG. 7.

Referring to FIGS. 7 and 8, the OLED display includes a substrate 100, a thin film display layer 200 formed on the substrate 100, and an OLED 70.

According to some embodiments, the substrate 100 is formed of a transparent glass or plastic. Further, the substrate 100 may be a flexible substrate.

The thin film display layer 200 includes a buffer layer 120, switching and driving semiconductor layers 154a and 154b, a gate insulating layer 140, a gate line 121, a first storage charging plate 128, an interlayer insulating layer 160, a data line 171, a driving voltage line 172, a switching drain electrode 175a, a driving drain electrode 175b, and a passivation layer 180.

The buffer layer 120 is formed on the substrate 100 and may be formed of a single layer of silicon nitride (SiNx) or a double layer structure in which silicon nitride (SiNx) and silicon oxide SiO₂ are laminated. The buffer layer 120 serves to planarize the surface of the substrate 100 while preventing impurities or moisture from penetrating through the substrate 100.

The switching and driving semiconductor layers 154a and 154b are formed on the buffer layer 120 and are spaced apart from each other. The switching and driving semiconductor layers 154a and 165b are formed of polycrystalline silicon and respectively include channel regions 1545a and 1545b, source regions 1546a and 1546b, and drain regions 1547a and 1547b. The source regions 1546a and 1546b and the drain regions 1547a and 1547b are respectively formed on opposing sides of the channel regions 1545a and 1545b.

The channel regions 1545a and 1545b are formed of poly silicon in which no impurities are doped, that is, the channel regions are 1545a and 1545b un-doped semiconductors, and the source regions 1546a and 1546b, and the drain regions 1547a and 1547b are formed of poly silicon in which conductive impurities are doped, that is, the source regions 1546a and 1546b, and the drain regions 1547a and 1547b are doped semiconductors.

The gate insulating layer 140 is formed on the channel regions 1545a and 1545b of the switching and driving semiconductor layers 154a and 154b. The gate insulating layer 140 may be a single layer or multiple layers which includes at least one of silicon nitride or silicon oxide.

The gate line 121 and the first storage charging plate 128 are formed on the gate insulating layer 140.

The gate line 121 extends in a horizontal direction to transmit a gate signal and includes a switching gate electrode 124a which protrudes from the gate line 121 over the switching semiconductor layer 154a. The first storage charging plate 128 includes a driving gate electrode 124b which protrudes from the first storage charging plate 128 over the driving semiconductor layer 154b. The switching gate electrode 124a and the driving gate electrode 124b respectively overlap the channel regions 1545a and 1545b.

The interlayer insulating layer 160 is formed on the gate line 121, the first storage charging plate 128, and the gate insulating layer 140.

A switching source contact hole 61a and a switching drain contact hole 62a which respectively expose the source region 1546a and the drain region 1547a of the switching semiconductor layer 154a are formed in the interlayer insulating layer 160. Further, a driving source contact hole 61b and a driving drain contact hole 62b which respectively expose the source region 1546b and the drain region 1547b of the driving semiconductor layer 154b are formed in the interlayer insulating layer 160.

The data line 171, the driving voltage line 172, the switching drain electrode 175a, and the driving drain electrode 175b are formed on the interlayer insulating layer 160.

The data line 171 transmits the data signal and extends in a direction intersecting the gate line 121 and includes a switching source electrode 173a which protrudes from the data line 171 and is connected to the switching semiconductor layer 154a.

The driving voltage line 172 transmits the driving voltage, is separated from the data line 171, and extends in substantially the same direction as the data line 171. The driving voltage line 172 includes a driving source electrode 173b which protrudes from the driving voltage line 172 and is connected to the driving semiconductor layer 154b. The driving voltage line also includes a second storage charging plate 178 which protrudes from the driving voltage line 172 to overlap the first storage charging plate 128. Here, the first storage charging plate 128 and the second storage charging plate 178 form a storage capacitor Cst with the interlayer insulating layer 160 as a dielectric material.

The switching drain electrode 175a is formed opposite to the switching source electrode 173a and the driving drain electrode 175b is formed opposite to the driving source electrode 173b.

The switching source electrode 173a and the switching drain electrode 175a are respectively connected to a source region 1546a and a drain region 1547a of the switching semiconductor layer 154a through a switching source contact hole 61a and a switching drain contact hole 62a. Further, the switching drain electrode 175a is electrically connected to the first storage charging plate 128 and the driving gate electrode 124b through the first contact hole 63 formed in the interlayer insulating layer 160.

The driving source electrode 173b and the driving drain electrode 175b are respectively connected to a source region 1546b and a drain region 1547b of the driving semiconductor layer 154b through the driving source contact hole 61b and the driving drain contact hole 62b.

The switching semiconductor layer 154a, the switching gate electrode 124a, the switching source electrode 173a, and the switching drain electrode 175a form a switching thin film transistor T1 and the driving semiconductor layer 154b, the driving gate electrode 124b, the driving source electrode 173b, and the driving drain electrode 175b form a driving thin film transistor T2.

A passivation layer 180 is formed on the data line 171, the driving voltage line 172, the switching drain electrode 175a, and the driving drain electrode 175b.

A second contact hole 185 which exposes the driving drain electrode 175b is formed in the passivation layer 180.

An OLED 70 and a pixel defining layer 350 are formed on the passivation layer 180.

The OLED 70 includes a pixel electrode 191, an organic emission layer 360, and a common electrode 270.

The pixel electrode 191 is formed on the passivation layer 180 and electrically connected to a driving drain electrode 175b of the driving thin film transistor T2 through the second contact hole 185 formed in the interlayer insulating layer 160. The pixel electrode 191 serves as an anode electrode of the OLED 70.

The pixel electrode 191 may be formed of a transparent conductive material such as indium tin oxide (ITO), indium zinc oxide (IZO), zinc oxide (ZnO) or indium oxide (In₂O₃) or a reflective metal such as lithium (Li), calcium (Ca), fluoride lithium/calcium (LiF/Ca), fluoride lithium/aluminum (LiF/Al), aluminum (Al), silver (Ag), magnesium (Mg), or gold (Au).

The pixel defining layer 350 is formed over the edges of the pixel electrode 191 and over the passivation layer 180.

The pixel defining layer 350 has an opening exposing the pixel electrode 191. The pixel defining layer 350 may be formed of a resin such as polyacrylates or polyimides.

The organic emission layer 360 is formed on the pixel electrode 191 in the opening in the pixel definition layer 350. The organic emission layer 360 is formed of multiple layers which include at least one of an emission layer, a hole-injection layer (HIL), a hole-transporting layer (HTL), an electron-transporting layer (ETL), and an electron-injection layer (EIL). When the organic emission layer 360 includes all of the above layers, the hole-injection layer is formed on the pixel electrode 191 which is an anode electrode and the hole-transporting layer, the emission layer, the electron-transporting layer, and the electron-injection layer are sequentially laminated thereon.

The organic emission layer 360 may include each of a red, green, and blue organic emission layer respectively emitting red, green, and blue light. The red, green, and blue organic emission layers are respectively formed in red, green, and blue pixels to implement a color image.

In some embodiments, the organic emission layer 360 in each of the red, green, and blue pixels includes each of the red, green, and blue organic emission layers. In these embodiments, red, green, and blue color filters are respectively formed over the red, green, and blue pixels to implement a color image. In other embodiments, a white organic emission layer which emits white light is formed in each of the red, green, and, blue pixels and red, green, and blue color filters are respectively formed over the red, green, and blue pixels to implement a color image. When the color image is implemented using the white organic emission layer and the color filters, a deposition mask used in depositing the red, green, and, blue organic emission layers is not required.

The white organic emission layer as described above can be formed as a single organic emission layer or can include a plurality of organic emission layers laminated to emit white light. For example, at least one yellow organic emission layer and at least one blue organic emission layer can be combined to emit white light, at least one cyan organic emission layer and at least one red organic emission layer can be combined to emit white light, and at least one magenta organic emission layer and at least one green organic emission layer can be combined to emit white light.

The common electrode 270 is formed on the pixel defining layer 350 and the organic emission layer 360. The common electrode 270 may be formed of a transparent conductive material such as ITO, IZO, ZnO or In₂O₃ or a reflective metal such as lithium, calcium, fluoride lithium/calcium, fluoride lithium/aluminum, aluminum, silver, magnesium, or gold. The common electrode 270 serves as a cathode electrode of the OLED 70.

While the described technology has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An organic light-emitting diode (OLED) display, comprising:
a substrate;
a thin film display layer formed over the substrate, wherein a plurality of OLEDs are formed in the thin film display layer;
an encapsulation substrate formed over the thin film display layer;
a touch sensing layer formed over the encapsulation substrate; and
a flexible printed circuit board connected to the substrate and the touch sensing layer,
wherein the flexible printed circuit board includes i) a display unit electrically connected to the substrate and ii) a touch unit extending from the display unit and electrically connected to the touch sensing layer.

2. The OLED display of claim 1, wherein the display unit includes a display terminal electrically connected to the substrate and wherein the touch unit includes a touch terminal electrically connected to the touch sensing layer.

3. The OLED display of claim 2, wherein the display terminal and the touch terminal are spaced apart.

4. The OLED display of claim 3, wherein the flexible printed circuit board further includes:
an input unit configured to receive a plurality of driving signals and a touch driving signal from an external source; and
a touch driver configured to receive the touch driving signal from the input unit and apply the touch driving signal to the touch sensing layer.

5. The OLED display of claim 4, wherein the input unit is formed in the display unit and the touch driver is formed in the touch unit.

6. The OLED display of claim 5, further comprising a signal driver formed over the substrate, wherein the display unit is configured to receive the driving signal from the input unit and apply the driving signal to the signal driver.

7. The OLED display of claim 1, wherein the touch sensing layer includes a plurality of first touch electrodes and a plurality of second touch electrodes spaced apart from the first touch electrodes and formed on the same layer as the first touch electrodes.

8. The OLED display of claim 7, wherein the first and second touch electrodes are alternately arranged so as not to overlap each other, wherein the first touch electrodes are arranged in a first direction and are electrically connected to each other via a plurality of first connection units, and wherein the second touch electrodes are arranged in a second direction crossing the first direction and are electrically connected to each other via a plurality of second connection units.

9. The OLED display of claim 8, wherein the first connection units are formed on the same layer as the first touch electrodes and are integrally formed with the first touch electrodes and wherein the second connection units are formed on a different layer from the second touch electrodes.

10. The OLED display of claim 9, further comprising:
a plurality of first touch wiring lines electrically connected to the first touch electrodes;
a plurality of second touch wiring lines electrically connected to the second touch electrodes; and
a touch pad unit electrically connected to the touch unit,
wherein the first and second touch wiring lines are electrically connected to the touch pad unit.

11. The OLED display of claim 1, wherein the touch unit is spaced apart from the substrate.

12. An organic light-emitting diode (OLED) display, comprising:
a substrate comprising a display area and a peripheral area;
a plurality of pixels formed in the display area;
a signal driver formed in the peripheral area and configured to apply driving signals to the pixels;
a touch sensing layer formed over the pixels; and
a flexible circuit board comprising a display input portion and a touch driver portion,
wherein the display input portion is electrically connected to the signal driver and wherein the touch driver portion is electrically connected to the touch sensing layer.

13. The OLED display of claim 12, wherein the flexible circuit board further comprises an input unit configured to receive the driving signals and a touch driving signal from an external source, wherein the display input portion is configured to receive the driving signals from the input unit and apply the driving signals to the signal driver, and wherein the touch driver portion comprises a touch driver configured to receive the touch driving signal from the input unit and apply the touch driving signal to the touch sensing layer.

14. The OLED display of claim 13, wherein the input unit is formed in the display input portion.

15. The OLED display of claim 12, wherein the display input portion comprises a display terminal electrically connected to the signal driver, wherein the touch driver portion comprises a touch terminal electrically connected to the touch sensing layer, and wherein the display terminal and the touch terminal are spaced apart.

16. The OLED display of claim 12, wherein the touch sensing layer comprises:
a plurality of first touch electrodes arranged in a first direction;
a plurality of second touch electrodes arranged in a second direction crossing the first direction;
a plurality of first touch wiring lines, wherein each of the first touch wiring lines is respectively electrically connected to one of the first touch electrodes; and
a plurality of second touch wiring lines, wherein each of the second touch wiring lines is respectively electrically connected to one of the second touch electrodes.

17. The OLED display of claim 16, wherein the touch sensing layer further comprises a touch pad electrically connected to the touch driver portion and wherein each of the first and second touch wiring lines is electrically connected to the touch pad.

18. The OLED display of claim 16, wherein the touch sensing layer further comprises:
a plurality of first connection units electrically connecting the first touch electrodes; and
a plurality of second connection units electrically connecting the second touch electrodes.

19. The OLED display of claim 18, wherein the first and second touch electrodes are formed on the same layer, wherein the first connection units are formed on the same layer as the first and second touch electrodes, and wherein the second connection units are formed on a different layer from the first and second touch electrodes.

20. The OLED display of claim 12, wherein the touch driver portion is spaced apart from the substrate.
